(19) United States
(12) Patent Application Publication
(10) Pub. No.: US 2017/0039287 A1
(43) Pub. Date: Feb. 9, 2017

(54) METHOD OF TRANSFORMING A 2D MOBILE SEARCH APP INTO A 3D MOBILE SEARCH APP

(71) Applicant: IQo International (HK) Limited, Kwun Ton (HK)

(72) Inventors: Erwin K.M. Lau, Kwun Ton (HK); Wilson Cho, Kwun Ton (HK); Y.k. Ma, Kwun Ton (HK)

(21) Appl. No.: 15/231,369

(22) Filed: Aug. 8, 2016

Related U.S. Application Data
(60) Provisional application No. 62/265,073, filed on Dec. 9, 2015.
(60) Provisional application No. 62/201,861, filed on Aug. 6, 2015.

(51) Int. Cl. G06F 17/30; G06F 3/0481

(52) U.S. Cl. CPC G06F 17/30867; G06F 3/04815; G06F 3/04842

(57) ABSTRACT

An existing two-dimensional search engine app (“2D Search App”) is transformed into a search engine that can present three-dimensional results (“3D Search App”), allowing the presentation of 3D sites and objects on a mobile device through a mobile App in communication with a central server. The client is capable of performing 3D rendering in accordance with the instructions received from the server. The client also interacts with the server to send and retrieve other data, including requests, instructions and text, images or video. The server is capable of converting 3D models into instructions which can be sent to the client, thereby allowing the client to reproduce the 3D model in the mobile device for viewing. The invention finds application in a wide range of fields, including fashion, retail outlets, and product demonstration and sales.

### REFERENCE TO RELATED APPLICATIONS

This application claims priority to U.S. Provisional Patent Application Ser. No. 62/201,861, filed Aug. 6, 2015 and U.S. Provisional Patent Application Ser. No. 62/265,073, filed Dec. 9, 2015, the entire content of both of which is incorporated herein by reference.

### FIELD OF THE INVENTION

The present invention relates generally to the Internet, including the mobile Internet. In particular, techniques and methods are disclosed that enable a search engine app on a mobile device to display true three-dimensional results, allowing the user of the search engine to navigate in a three dimensional site or circumnavigate a three dimensional object and interact with the same.

### BACKGROUND OF THE INVENTION

According to Wikipedia, “Competition for the . . . mobile search market promises to be fierce, thanks to the large . . . online ad market and strong pushes by portals.” In addition to native search engines, such as the Safari for the iOS systems, major search engines such as Google and Baidu in China have introduced downloadable applications to extend their search engine businesses. Currently all mobile search engine Apps (“2D Search Apps”) present results in two dimensions, which may include text, images or video. There is a need, however, to present certain results in three-dimensions, for example, a building, a store or a three dimensional object such as a 3D car model.

It is believed that having this capability will increase the attractiveness of search results to users, as they can have a three-dimensional experience, either in viewing an object or in entering and interacting with a scene. For the same reason, it is believed that owners of conventional two-dimensional websites may also want to convert their websites from two to three dimensional, so that when presented to the users, their websites will be more attractive.

### SUMMARY OF THE INVENTION

This invention resides in a method transforming an existing two-dimensional search engine app (“2D Search App”), into a search engine that can present three-dimensional results (“3D Search App”), as well as a system for the production of the three-dimensional contents. The conversion process rapid, the 3D Search App adds no more than 10 MB to existing 2D Search Apps, and can be released as a normal version upgrade.

The technology, which allows the presentation of 3D sites and objects on a mobile device, comprises a client in the form of a mobile App in communication with a central server. The client is capable of performing 3D rendering in accordance with the instructions received from the server. The client also interacts with the server to send and retrieve other data, including requests, instructions and text, images or video.

The server is capable of converting 3D models into instructions which can be sent to the client, thereby allowing the client to reproduce the 3D model in the mobile device for viewing. These 3D models may be imported from model building applications such as 3D Max or Sketch Up, or by way of a proprietary template-based customization backroom.

The invention finds application in a wide range of fields. As one example, a fashion brand which currently has an online store may wish to present its search result in a 3D store which the user can enter and view products which are available. In this case, the fashion brand may select the standard 3D Option. A 3D Backroom will automatically create the 3D store (size of store to be selected by the brand) and populate the store with products of the brand in synchronization with its online store.

As another example, a restaurant may wish to present its search result in 3D which highlights its environment and settings. In this case, it may wish to modify certain standard models to display logo, decoration or images not contained in its 2D website. This can mostly be accomplished in the customer version of the 3D Backroom. Or a hotel may wish to present its search result in 3D to highlight the various facilities it has, and permits the user to view its various rooms. In this case, the hotel may need to utilize expert 3D model construction services to construct a customized 3D model for the various areas that the hotel wishes to exhibit.

### BRIEF DESCRIPTION OF THE DRAWINGS

FIG. 1 is a diagram that illustrates the flow of information enabling a 3D search result according the invention; and

FIG. 2 are flowcharts that illustrate site registration (right flowchart) and search engine operations (left flowchart).

### DETAILED DESCRIPTION OF THE INVENTION

This invention has two primary components: A first part that enables a 2D Search App to Display 3D results, and a second part involving the production of the 3D results.

### Part 1—Enabling a 2D Search App to Display 3D Results

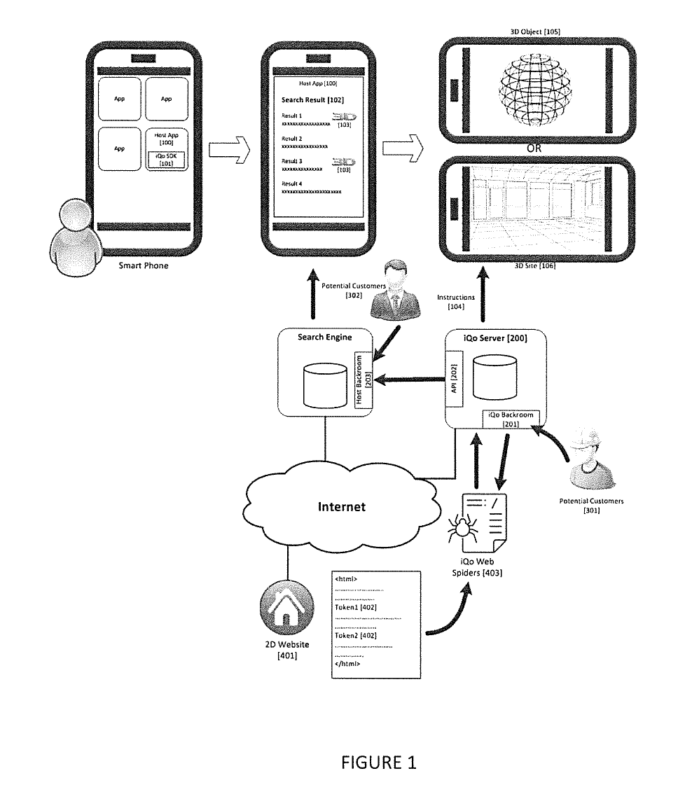

The elements involved in this aspect of the enabling process are as follows, wherein the numerical references may be found primarily in FIG. 1:

1) A downloadable App 101 capable of displaying 3D results (the “Client”), either as a 3D object 105 at which users can view from different angles, or as a 3D site 106 in which users can move about freely. In both cases, users can further interact with the 3D object or 3D site to obtain additional 2D or 3D information.

2) Server 200 connected to the Client 101 can send instructions in real time to construct or erect the various 3D objects or 3D sites, as well as transmitting rules for further interactions and receiving requests or reports from the Client.

3) A Software Application or Development Kit (“SDK”) 101 which allows the Client to be attached to, and to interact with, any 2D Search App (“Host App” 100). Once the Client 101 is attached to Host App 100, the Host App can define the circumstances under which the Client is invoked by the user, and conditions for the user to return to the Host App. The 2D Search App can then introduce a version upgrade with the Client as an attachment.

4) A Backroom residing on the Server 200 receives information or instructions from potential customers for the construction of 3D models or sites, so that such 3D models or sites can be displayed in 3D with the correct information to search engine users. Due to the potential variety of needs from customers, certain level of customization may require manual assistance or participation by expert Backroom operators.

5) An Application Programming Interface 202 (“API”) which connects the Backroom with the backroom of the 2D Search App (or Host App), allowing the exchange of information, including whether or not a particular website contains 3D results which could be displayed by invoking the Client, and whether or not a customer desires to construct a 3D website (in which case, the backroom of the 2D Search App will refer the customer to the 3D Backroom.

In order to transform a 2D Search App into a 3D Search App, all that is required is for the 2D Search App to utilize the SDK to attach the Client to its 2D Search App (which becomes the Host App), modify the 2D Search App to set the conditions for invoking the Client, and publish the new hybrid App as an update version to its current 2D Search App.

### Part 2—The Production of 3D Results

The elements involved in the process relating to the production of 3D results to be displayed in the 3D Search App are as follows:

1) Backroom 203 (“Host Backroom”) for the 2D Search App (or Host App) which is used for interacting with potential customers 302 interested in placing advertising or performing various search engine optimization functions.

2) 3D Backroom 201, which receives information or instructions from potential customers 301 for the construction of 3D models or sites, so that the 3D models or sites can be displayed in 3D with the correct information to search engine users.

3) An Application Programming Interface (“API”) 202 which connects the 3D Backroom with the Host Backroom, allowing the exchange of information, including but not limited to whether or not a particular website contains 3D results 103 which could be displayed by invoking the Client, and whether or not a customer desires to construct a 3D website. If this is the case, the Host Backroom will refer the customer to the 3D Backroom; and if the customer indeed constructs 3D results, the 3D Backroom will so notify the Host Backroom. Where applicable, the 3D Backroom may complete a payment process (if any), or provide necessary information for the Host Backroom to complete part or all of the payment process.

The production of 3D results can be accomplished in one or more steps, as follows:

1) Converting a 2D website 401 into a standard 3D Website 106 containing some or all of the information in the website:

a) The customer utilizes a website or a mobile App, or a combination of both, which are connected to the 3D Backroom, to select the 3D structure he/she wishes to present based upon a number of different selections.

b) On each selectable structure, special locations or spots will be marked with identifications. Such locations or spots can display text, images or video information otherwise contained in the one or more 2D websites.

c) Certain special tokens 402 (including hypertext symbols or text) will be made available to the customer. The customer inserts the tokens (associated with particular spots locations or spots in the 3D structure) in the hypertext markup language used to power their 2D website(s) in accordance with instructions to indicate which information is to be displayed on which location or spots.

d) The 3D Backroom notifies the Server, which sends out a web spider 403 to the website(s), finds the special tokens, and retrieves the information identified by the special tokens.

e) The retrieved information, together with special tokens which identifies the locations or spots on which it is to be displayed, are then incorporated into the 3D rendering instructions 104 to be communicated to the Client to construct the 3D website containing the desired information. In the event that the information selected exceeds the permitted space within the 3D site, excess information will be made available as additional pages (which can be scrolled or turned or otherwise) viewable by the user.

f) Upon review and approval of the customer (optional), the 3D Website will reside on the Server.

g) The Server will notify the Host Server that the customer (identified by their 2D website or websites) has successfully produced a corresponding 3D Website, so that when a search event occurs and the customer's website or websites are to be displayed, a special symbol 103 will be inserted in the search result display 102 to indicate that this customer has a 3D Website.

h) If the search engine user taps on the special symbol, the 3D Search App will call up the Client connected by the SDK, and the user will enter into a 3D site where he will be able to navigate, view and interact with the information presented in a real 3D experience.

i) There are default modes for the selection of structure and the placement of information so that the customer need not make all selection decisions.

j) The 3D Backroom can further streamline and simplify the token placement process for customers who utilize some of the major Content Management Systems (such as Joolma), as the process will be integrated into such systems.

2) Converting a 2D website into a customized 3D Website containing some or all of the information in the website:

a) In cases where the customer desires customization beyond the selection of 3D structure and placement of information, including the insertion of information other than on the 2D websites, the customer can utilize the customer version of the 3D Backroom.

b) In this version of the 3D Backroom, the customer can have a greater range of selection including, but not limited to, additional building styles, 2D decorations, 3D decorative objects, wall and floor textures and styles for text.

c) If further customization is needed, including the creation of 3D sites not within the selection, the customer can utilize expert services.

3) Inserting custom 3D objects:

a) In some cases, the customer may wish to display custom 3D objects instead of or in addition to 3D sites, for example, an automotive brand displaying its new model car.

b) The 3D Backroom can accept standard 3D models from a number of major 3D rendering software tools and convert them into a 3D format for display.

c) In some cases, the customer can utilize expert services to construct these 3D models.

d) When constructed, the 3D models can be placed into the 3D sites, or individually called up to be displayed in the 3D Search App.

e) The 3D objects can move within 3D sites, for example, a 3D car model can rotate on a pedestal to simulate a showroom, or even drive through a 3D virtual city to simulate a test drive.

4) 3D Websites with user-user interaction:

a) If, at a given time, more than one search engine user is viewing the same 3D site, then symbols (or avatars) representing these users can be made visible to other users with the placements of these symbols representing the actual location of these users as they navigate about within the 3D site, simulating a real-life encounter in a 3D environment.

b) These users can communicate with one another by tapping the symbol of the target, utilizing text, graphics (expressions) or voice.

c) If these users are registered, thereby having identifications, friends' lists or fans' lists can be created so that users can socialize further.

Typically, when a search result contains a 3D object or site, a symbol will appear on the screen of the user's mobile device. When the user taps that symbol or icon, the Client will be activated, and the user will be able to navigate or circumnavigate in the 3D site or object and interact with it. When the user is done with the 3D activities, they will be returned to the point where they first activated the 3D technology. Other possible User Interface arrangements can also be utilized.

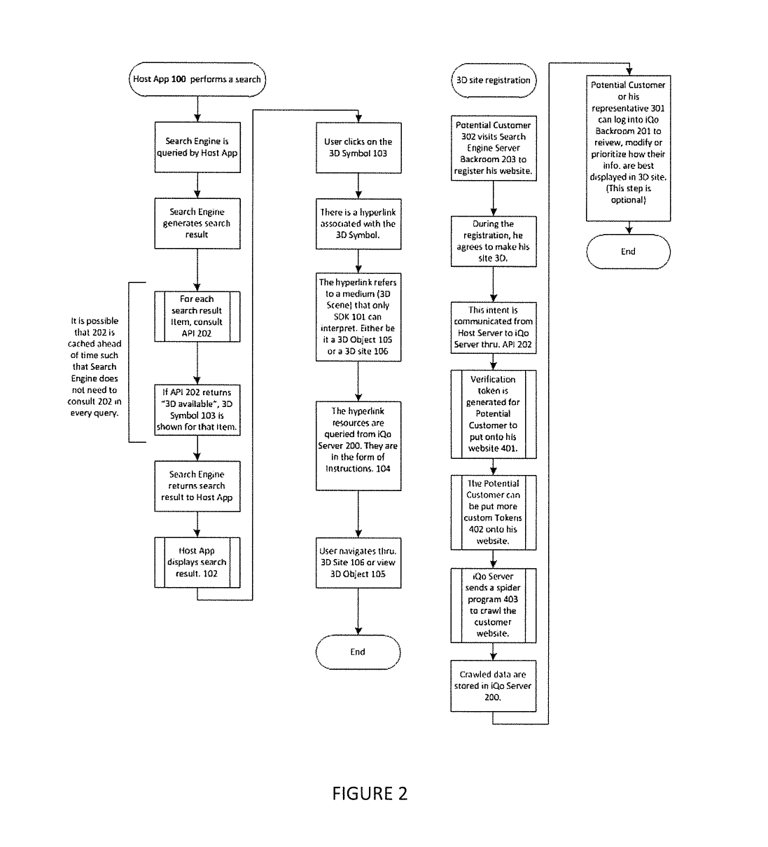

The flowcharts shown in FIG. 2 provide an example of processes that occur on both Client side and the Server side. The flowcharts are provided solely to facilitate the understanding of the processes, with the understanding that the sequence of events depicted in the flowcharts is only one of the many ways the processes may occur.

The right-side flowchart of FIG. 2 illustrates how 3D scenes are constructed. When a Potential Customer 302 visits Search Engine Server Backroom 203 to register a website, the user may select to make the website a 3D Website. This intent is communicated from the Search Engine Server to a Server 200 through API 202.

Utilizing a website or a mobile app connected to the 3D Backroom 201 , the Potential Customer 302 can insert tokens 402 to identify which 3D structure is to be displayed on which location or spot. The Backroom 201 then notifies the Server 200, which will then send out Web Spider 403 to crawl the Customer website to find the tokens and retrieve the information identified by the tokens. The crawled data, including the retrieved information along with the tokens which identified the locations or spots on which the information is to be displayed, will then be stored in the Server as 3D Rendering Instructions 104.

The left-side flowchart illustrates how a Client 101 communicates with a Server 200 to display 3D search results. When a user runs a search using Host App 100 available on a website or a mobile phone, Search Engine is queried by the Host App 100 to generate and return a list of search results. For each returned search result item, API 202 located on Server 200 is consulted to see whether there is 3D version available. If API 202 indicated there is an available 3D version, a 3D Symbol 103 is shown next to the item in the list results. The user can then click on the 3D Symbol 103 to access a hyperlink associated with the 3D Symbol. The hyperlink refers to a medium that displays a 3D scene. The 3D scene may be a 3D Object 105 or a 3D site 106. The 3D scene resides on Server 200. Only a Host App attached with an 3D-capable Client 101 can view the 3D scene. Upon receiving a request from the user to display the 3D scene, the Client 101 will construct the 3D scene on the locations or spots according to its interpretation of the 3D rendering instructions 104.

1. A method of providing three-dimensional (3D) search results in response to a search request, comprising the steps of:
performing a registration process at an Internet server enabling 3D results to be returned from an existing Internet website in response to a search request;
wherein the registration process includes the placement of a token at a 3D-enabled location in the website indicating that 3D imagery is to be displayed when that location is accessed by a user; and
whereby, when the user of a mobile device accesses the Internet website, the 3D imagery is displayed on the mobile device when the user accesses the 3D-enabled location in the website.

2. The method of claim 1, wherein the server sends out a web spider to crawl the Internet website to find the tokens and retrieve information identified by the tokens.

3. The method of claim 1, wherein the server converts a 3D model of the 3D imagery into instructions and sends the instructions to the user enabling the 3D imagery to be displayed on the mobile device.

4. The method of claim 1, wherein the 3D imagery includes a 3D object which a user may choose to view at different angles on the display of the mobile device.

5. The method of claim 1, wherein the 3D imagery includes a 3D space which a user may choose to explore on the display of the mobile device.

6. The method of claim 1, wherein the 3D imagery enables the user to select additional 2D or 3D information.

7. The method of claim 1, wherein the server presents a user with a plurality of selections associated with the 3D imagery that the user wishes to display.

8. The method of claim 1, wherein the 3D imagery includes selectable locations to display text, images or video information contained in the Internet website.

9. The method of claim 1, wherein if a search request returns a result that is 3D enabled, that result is marked with a symbol or icon to indicate that the website is 3D enabled.

10. The method of claim 1, including the step of enabling a user to specify custom 2D or 3D decorative effects when the 3D imagery is displayed.

11. The method of claim 1, including the step of accepting 3D models from an existing 3D rendering software tool to generate the 3D imagery for display.

12. The method of claim 1, including the step of displaying symbols or avatars representing multiple users navigating the same 3D-enabled website.

13. The method of claim 12, wherein the multiple users communicate with one another by tapping the symbol of the target, utilizing text, graphics (expressions) or voice.

14. The method of claim 12, including the step of creating identifications, friends or fans enabling the multiple users to socialize on the website.
